(19) United States
(12) Patent Application Publication
(10) Pub. No.: US 2023/0148613 A1
(43) Pub. Date: May 18, 2023

(54) DEVICE FOR PRODUCING FOOD DOUGH

(71) Applicant: Armand-Gérard KAMANDA, Neuchatel (CH)

(72) Inventor: Armand-Gérard KAMANDA, Neuchatel (CH)

(21) Appl. No.: 17/905,698

(22) PCT Filed: Mar. 3, 2021
(86) PCT No.: PCT/EP2021/055397

§ 371 Date: Oct. 14, 2022

(30) Foreign Application Priority Data
Mar. 4, 2020 (FR) FR2002180

(51) Int. Cl. A21C 1/08; B01F 31/55; B01F 35/45; B01F 35/92

(52) U.S. Cl. CPC A21C 1/08; B01F 31/55; B01F 35/454; B01F 35/92; B01F 2035/99

(57) ABSTRACT

The present disclosure relates to a device for producing food dough including an at least partially elastically deformable membrane containing ingredients of said food dough and deformation parts adapted to deform the membrane operating from the outside of the container formed by the membrane.

The present disclosure relates to the food industry sector and more precisely to the apparatuses allowing for preparing food products obtained by processing a food dough, such as a bread dough, a cake dough, a fufu (also called foufou).

The preparation of this dough generally includes the following three steps:
cooking all or part of the ingredients,
mixing the ingredients and
kneading the ingredients to obtain the dough.

Machines for preparing dough generally includes of a container, in which all the ingredients to be mixed are collected, and a mechanical element, which comes into contact with these ingredients inside the container to mix them in order to obtain the desired food dough. Examples of mechanical elements known for this type of device are kneading arms, hooks, or stars.

Such machines involve separating a large portion of the prepared dough from the mechanical element which was used for the kneading step once the kneading of the dough is finished. Such a manual operation by the operator is tedious and a non-negligible portion of the dough cannot be separated from the mechanical element, this part therefore being lost.

Moreover, these machines do not always offer sufficient dough quality, so some users continue to resort to traditional preparation techniques where all the steps are carried out manually.

Lastly, another disadvantage is that the contact between the mechanical element and the ingredients may cause a denaturation of the final flavor of the dough, for example if the mechanical element has not been cleaned sufficiently well after the previous use or if it shows signs of wear. Such a disadvantage appears all the greater in an industry where hygiene standards are paramount.

So-called traditional dough preparation techniques have been known for even longer. These traditional techniques do not always involve some of the previously mentioned drawbacks. However, these traditional techniques involve many manual operations and are generally much longer than preparations using the machines previously described. Such traditional techniques are physically demanding for the user, who must generally alternate between several different movements over a considerable period of time.

The object of the present disclosure is in particular to solve both the drawbacks of current machines and of traditional techniques.

To this end, the subject of the present disclosure is a device for making food dough, characterized in that it comprises:
an at least partially elastically deformable membrane forming a container having a volume intended to contain the ingredients of said food dough,
means for deforming the membrane suitable for temporarily reducing the volume of the container, the deformation means operating from outside the container.

Thus, the device of the present disclosure allows for food dough to be made while overcoming all the drawbacks mentioned above. Indeed, such device makes it possible to overcome the need to use a mechanical element coming into contact with the ingredients and, consequently, makes it possible to overcome the drawbacks associated with the use thereof. For example, it is no longer necessary to separate the dough from the mechanical element at the end of preparation, or to wash the mechanical element, which significantly reduces dough losses. This device also makes it possible to avoid any tedious manual step of the traditional techniques for making the dough. Lastly, the device of the present disclosure also offers better compliance with the hygiene standards in force, since no element comes into contact with the ingredients intended to form the dough. It also reduces the risk of denaturing the final flavor of the dough.

The membrane of the device of the present disclosure may be made from any material or combination of materials allowing elastic deformation of at least part of the membrane. A suitable material for this type of membrane is, for example, silicone, which also has the advantage of being washable and reusable. This membrane forms a container in which the ingredients of the food dough are placed and then mixed. These ingredients are mixed under the indirect action, from outside the container, of the means for deforming the membrane. The action of said means therefore takes place on the outer wall of the membrane and no contact between the deformation means and the ingredients occurs throughout the manufacturing process of the food dough.

Advantageously, the deformation means comprise at least one rotating element.

Thus, the deformation of the membrane and, by extension, the kneading of the ingredients are optimized, since a regular pattern of deformation is possible given the rotation of the rotary element of the deformation means. Such a pattern may, for example, make it possible to reproduce the combination of crushing and sliding that the dough undergoes under the action of a pestle in a mortar or when it is crushed against the walls of a container by a kneader arm.

Advantageously, the means for deforming the membrane comprise at least two distinct rotary elements operating on distinct locations of the membrane.

Thus, the advantages mentioned above are increased tenfold, since the membrane is deformed in distinct locations which ultimately ensures better mixing of the ingredients and better kneading.

Advantageously, the two rotating elements are located on either side of the membrane, which allows better coordination of the deformation movement and thus better kneading of the dough.

Advantageously, the device of the present disclosure comprises means for supporting the membrane suitable for keeping it translationally stationary, which makes it possible in particular to secure the positioning of the membrane within the device. Consequently, the process of deforming the membrane by the deformation means may be carried out with more precision. This stationary hold by the support (and its fixed part) also makes it possible to use the elasticity of the membrane, which thus held always tends to return to its initial position after the action of the deformation means. Thus, it is possible to obtain a dough gathering cycle (i.e. restore it to a non-crushed shape) between two cycles of crushing by the deformation means. Such a sequence reproduces the movements of kneading by hand or in a mortar and makes it possible to obtain a better quality of dough at the end of preparation.

Advantageously, the support means comprises at least one fixed part and at least one movable part, which, when moved from a first position to a second position, allows direct contact between the membrane and the deformation means.

Thus, the support means forms, in its first position, a container having a simple appearance, which leaves the exterior of the membrane invisible and inaccessible, and which has a single opening giving access to the volume of the container. In its second position, the movable part of the support means is moved relative to its fixed part. Such displacement between the two parts of the support means allows direct contact between the membrane and the deformation means, thus making the deformation of the membrane and the mixing of the ingredients possible under the action of the deformation means.

Advantageously, the support means has a circular shape, the movable part being moved after the application of a predetermined torque to the movable part.

Thus, the application of a torque on the movable part generates a rotational movement of said movable part relative to the fixed part of the support means. When the movable part is moved, the outer part of the membrane is accessible to the deformation means. To do this, many systems are known. For example, holes of corresponding sizes and shapes may be provided in the fixed part and the movable part of the support means so that, at the end of the rotational movement of the movable part, these holes are opposite each other, thus allowing access to the outer wall of the membrane.

Advantageously, the device of the present disclosure comprises at least one insert connected to the membrane and making it possible to transfer heat to the membrane. It is therefore possible to raise the temperature of all or part of the ingredients placed in the container formed by the membrane. Such a rise in temperature makes it possible to cook its ingredients.

Advantageously, the device comprises a member for closing the membrane arranged to seal the container after the application of a predetermined rotational torque to the membrane.

Advantageously, the membrane comprises several compartments, each compartment being intended to collect one or more ingredients.

Thus, it is possible to keep the ingredients separate from each other before their final mixing, which makes it possible, for example, to cook them independently of each other and to mix them only once the cooking has been completed. To this end, the insert may be designed so as to be able to provide heat to one or the other of the compartments separately.

Advantageously, the device comprises a casing arranged to form a protective envelope for the entire device. Advantageously, the casing is provided with a touch screen.

### BRIEF DESCRIPTION OF THE FIGURES

The various embodiments will be better understood upon reading the description which follows, given solely by way of example and with reference to the appended drawings in which:

FIG. 1 is a perspective view and a sectional view showing a device according to a first embodiment.

FIG. 2 is a perspective view and a sectional view of the device according to the first embodiment in a second position of the membrane support means.

FIG. 3 is a schematic view showing different stages of the process of deforming the membrane by the deformation means.

### DETAILED DESCRIPTION

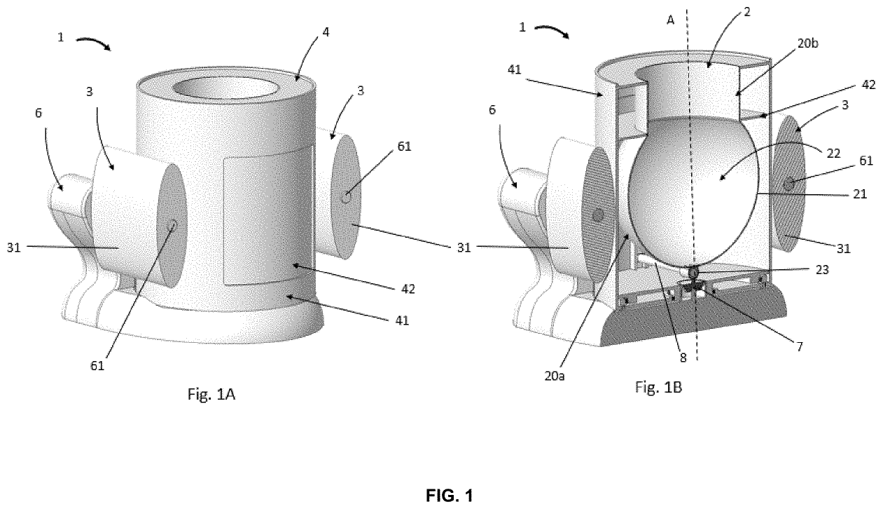

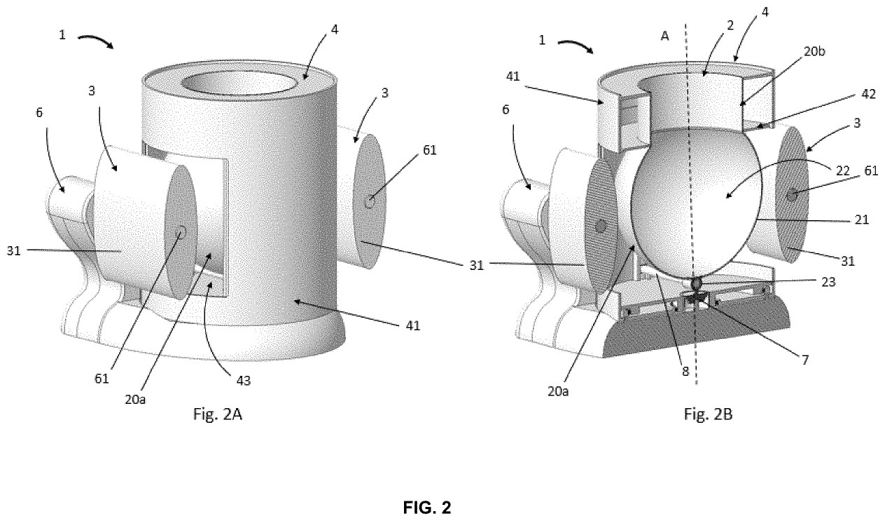

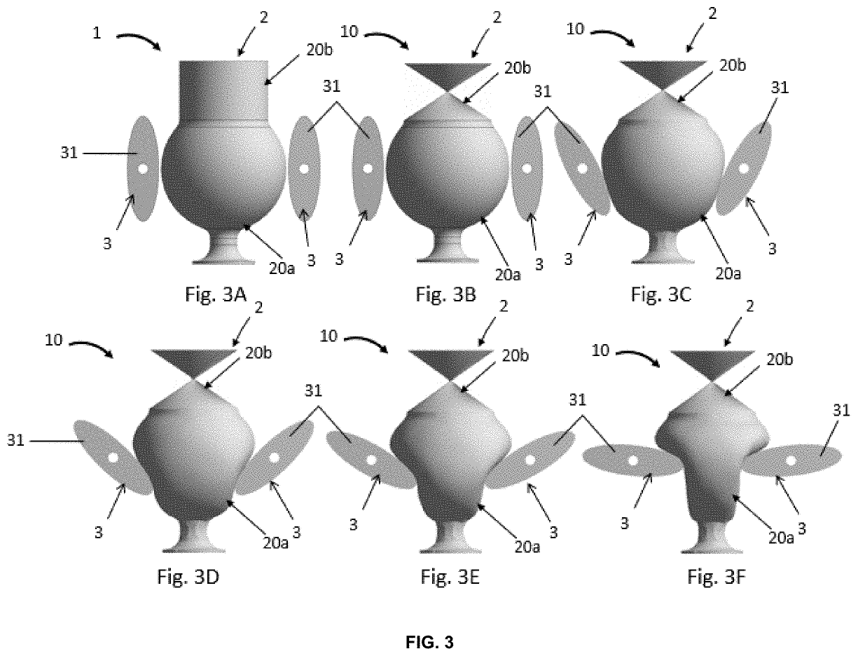

FIGS. 1 and 2 show perspective views and the associated sections of the food dough production device 1 of the disclosed embodiment according to two different positions of the membrane support means. FIGS. 3A to 3F show the different operating steps of the device 1. For greater clarity, the support means 4 has been deliberately removed from FIGS. 3A to 3F.

The food dough production device 1 comprises an at least partially elastically deformable membrane 2 forming a container 21 having a volume 22 intended to contain ingredients (not shown) of said food dough and means 3 for deforming the membrane 2 adapted to temporarily reduce the volume 22 of the container 21, the deformation means 3 operating from outside the container 21.

The membrane 2 forming the container 21 may have any structure allowing an elastic deformation of the container 21 by the deformation means 3. In the embodiment represented in FIGS. 1A to 3F, the membrane 2 is composed of two portions, namely a lower portion 20a, with a spherical shape, and an upper portion 20b, with a cylindrical shape with a round base. This structure is not limiting, as the upper 20b and lower 20a portions may have other shapes that are different from each other or the same shape.

The membrane 2 is held translationally stationary within the device 1 by a support means 4 of said membrane 2. This support means 4 may be made of any material and have any suitable shape making it possible to ensure translationally stationary support of the membrane 2. In the embodiment described, the support means 4 is also cylindrical in shape with a round base. More specifically, the connection between the membrane 2 and the support means 4, helping to hold the membrane 2 translationally stationary within the device 1, is made between the upper portion 20b and a fixed part 42 of the support means 4, both being correspondingly cylindrical in shape.

The lower portion 20a of the membrane 2 comprises a cylindrical loop 23 to which an insert 7 made of a thermally conductive material is linked. It may, for example, be a metal insert. The insert 7 is also linked to a base 6 so as to prevent any translational movement of the insert 7 with respect to the base 6. These connections may be provided by any method known to those skilled in the art, for example, by riveting, gluing, or overmolding the insert 7. In addition, the insert 7, made of a thermally conductive material, allows the heat to be conducted towards the lower portion 20a when the insert 7 is heated by the base 6. Thus, the ingredients contained in the container 21 are heated, which ultimately allows them to be cooked before or during the kneading step or to keep the dough obtained after this step warm.

A stabilizer bar 8 is inserted into the cylindrical loop 23 and is connected to the insert 7. This bar 8 extends transversely over the entire width of the support means 4. It ensures a translational and rotational locking of the lower portion 20a of the membrane 2 with respect to the support 4 and contributes to the stability of the membrane 2 notably during the kneading step, when the membrane 2 is deformed by the deformation means 3. This stabilizer bar 8 thus prevents the deformation means 3 from pushing the membrane 2, which would limit the deformation and harm the quality of the kneading, especially in the case where the maximum deformation of each deformation means 3 would not be reached at the same time.

Advantageously, the ends of the stabilizer bar 8 are introduced into guides, one of which is visible in FIGS. 1B and 2B. This makes it possible to envisage a translation of the stabilizer bar 8 in a direction parallel to the revolution axis of the upper portion 20a (hereinafter “axis A”) of the membrane 2, for example under the action of a telescopic arm included in the base 6 and making it possible to control the movement of the insert 7 and of the stabilizer bar 8 in translation along the axis A. Such a displacement has the effect of subdividing the lower portion 20a of the membrane 2 into two parts, forming two separate compartments in the container 21. Another possibility of kneading is therefore obtained in addition to those offered by the deformation means 3. It is also possible to arrange the ingredients separately within the container 21 at the start of preparation in order to be able to provide heat to two distinct groups of ingredients before gathering them in the same container to mix them.

In advantageous embodiments of the present disclosure not shown, each of the previously mentioned connections between the insert 7 and the cylindrical loop 23 or between the insert 7 and the base 6 is reversible so as to be able to separate, one by one, the elements forming the device 1. For example, the connection between the insert 7 and the base 6 is reversible, which makes it possible to separate the base 6 and the assembly formed by the membrane 2, the support means 4, the insert 7, and the bar 8. This embodiment is advantageous when the user wishes to transport said assembly, for example when the dough is ready and may be served at the table. The user may therefore transport an assembly comprising the dough prepared independently of the base 6, the weight of which may be significant. It may therefore be envisaged that the base 6 comprises a pin, which fits inside a notch made at the base of the insert 7 when the aforementioned assembly is placed on the base 6.

In another example, all the connections with the membrane 2 are reversible, which makes it possible to separate said membrane from any other element of the device 1. This embodiment is particularly advantageous if the user wishes to clean the membrane 2 independently of the other elements of the device 1.

The support means 4 also comprises a movable part 41 distinct from the fixed part 42 and able to move rotationally about the axis A. The displacement of the movable part 41 relative to the fixed part 42 allows the holes 43 provided in the movable part 41 and openings (not shown) on the fixed part 42 to be matched. The holes 43 are of sizes and shapes which allow the deformation means 3 to access the membrane 2. More specifically, matching the holes 43 and the openings provided in the fixed part 42 and the deformation means 3 provides said deformation means with an access to the outer wall of the lower portion 20a of the membrane 2. In addition, the movable part 41 is connected to the base 6 via a connection that only allows rotation about the axis A, when a predefined rotational torque is transmitted to the movable part 41.

Finally, in an advantageous embodiment, the movable part 41 is also integral with the upper portion 20b, thus forming a member for closing the membrane 2. In fact, and taking into account the separate connections between the upper portion 20b and the fixed 42 and movable 41 parts of the support 4 and the connection between the lower portion 20a and the stabilizer bar 8, the rotation of the movable part 41 causes, in addition to matching the holes 43 and the deformation means 3, a localized deformation of the upper portion 20b which achieves the sealed closure (shown in FIGS. 3B to 3F) of the container 21 formed by the membrane 2. One end of the upper part 20b will pivot while the other end is stationary, which has the effect of creating a twist in the upper part 20b, closing it at its center. In other words, it is no longer possible to access the inner volume 22 of the container 21 after the application of a predetermined rotational torque on the membrane 2. This rotational torque is applied to the upper portion 20b of the membrane 2, by the movable part 41. The rotation of the movable part is controlled by the support 6 which provides the necessary rotational torque.

The deformation means 3 of the device 1, according to the embodiment described in these figures, comprise two rotary elements 31 (cams 31), located on either side of the membrane 2 (the number of cams 31 may of course vary). Each cam 31 is fixed on a shaft 61 driven by a motor (not shown) and which supplies a rotational torque to the cam 31. The cams 31 each have a cylinder shape, the base of which is an elongated ellipsoid of revolution. However, the deformation means 3 of the device 1 of the disclosed embodiment are not limited to this geometric shape and may have any geometric shape, for example an oblong or oval shape, making it possible to ensure a deformation of the lower portion 20a resulting in proper kneading of the food. During rotation, each of the cams 31 comes into contact with the outer wall of the lower portion 20a of the membrane and deforms it, thus allowing a kneading step without interaction within the inner volume 22 of the container 21. The movement of the cams 31 to deform the membrane 2 is not limited to a rotational movement. Indeed, it is entirely possible for the deformation means 3 to comprise arms, each connected to a cam 31, which make it possible to carry out more complex movements of the cams 31. Such movements may combine rotation and translation of the cams 31, according to predetermined sequences, depending on the type of kneading desired.

The device 1 of the present disclosure according to the embodiment described with reference to FIGS. 1A to 3F operates as follows.

In a first position (FIGS. 1A and 1B), the support means 4 forms a solid cylindrical body, making the membrane 2 inaccessible to the cams 31. In this first position, the membrane 2 forms a container 21, the volume 22 of which is accessible via the upper portion 20b.

A predetermined rotational torque is applied to the movable part 41 of the support means 4, which has the effect of rotating the movable part 41. This rotational movement of the movable part 41 results in the matching of the holes 43 with the cams 31 (FIGS. 2A and 2B), as well as the closure of the container 21, which then forms a sealed volume. This is the second position of the support means 4 (FIGS. 3B and 3F). In this preferred embodiment, these two functions, namely the closure of the container 21 and the matching of the holes 43 provided in the fixed part 42 and the movable part 41, are both carried out via the single operation of rotation of the moving part 41. However, these two functions may also each be performed differently. For example, the container 21 may be closed using any other known means of closure allowing tight closure, such as press studs or a zipper.

The cams 31, initially parallel to the axis A (FIG. 3A), are in turn set in motion (FIGS. 3B to 3F), which has the effect of deforming the membrane 2 in its lower portion 20a. This step corresponds to the step of kneading the ingredients and lasts for a defined period which depends on the type of dough that one wishes to produce. In the example illustrated, the two cams 31 are synchronized so that the maximum deformation of the membrane 2 by the two cams 31 is reached at the same time. This could be different.

For example, according to an embodiment not shown, the cams 31 have a convex shape and a concave shape, respectively, both complementary to and adapted to match the shape of the solid membrane. In this embodiment, the concave cam performs a translational movement to match an area of the lower portion 20a of the outside of the membrane 2, while the other cam performs a rotational movement in combination with a translational motion, so that the cams are brought together. Then, the convex cam rolls without slipping over the concave cam. The volume reduction is thus optimized and the dough kneading is better controlled.

The ingredients contained in the container may be heated before, during, or after the kneading step. Heating after the kneading step is advantageous if it is desired to keep the dough at a certain temperature before serving it. In the embodiment described in FIGS. 1A to 2B, the insert 7 comprises a resistor, thus allowing it to transform the electrical energy provided by the base 6 into heat diffused throughout the metal zone of the insert 7. Said insert may contain flexible metal branches (not shown), for example strips or filaments, reaching selected areas of the lower portion 20a to optimize and distribute the heat input. The transmission of heat from the various branches of the insert 7 to the membrane takes place by simple conduction. Any other mechanism making it possible to transmit heat to the lower portion 20a, and therefore to the ingredients contained, may be suitable for the device of the present disclosure.

The device 1 of the present disclosure according to the embodiment described with reference to FIGS. 1A to 3F comprises a base 6 on which numerous other elements of the device 1 of the disclosed embodiments are fixed.

However, the device of the present disclosure is not limited to this advantageous embodiment, in which the device comprises said base 6. In other words, the disclosed embodiments also covers an embodiment in which the device has no base 6. Therefore, the movable part 41 and the fixed part 42 may be maintained in a relative fixed position by any other mechanical means (clips, retractable pin, magnetic contact), so that it is possible to move them manually from one configuration to another without the presence of a base 6. In this sense, the cams 31 may be actuated manually, for example by a crank, making the presence of a motor unnecessary.

In another embodiment of the present disclosure, the support comprises a single fixed part 42 provided with the holes necessary for the deformation of the membrane 2 by the deformation means 3. The membrane 2 is therefore permanently visible, which makes it possible to provide a support means that is less complex, lighter, and therefore less expensive.

What is claimed is:

1. A device for the production of food dough, characterized in that it comprises:
a membrane, at least partially deformable elastically, forming a container having a volume to contain ingredients of said food dough,
deformation parts of the membrane to temporarily reduce the volume of the container, wherein the deformation parts operate from outside the container.

2. The device according to the claim 1, wherein the deformation parts comprise at least one rotating element.

3. The device according to claim 1, wherein the deformation parts adapted to deform the membrane comprise at least two distinct rotating elements operating on distinct locations of the membrane.

4. The device according to claim 3, wherein the at least two rotating elements are located on either side of the membrane.

5. The device according to claim 1, comprises a support adapted to support the membrane, wherein the support is adapted to keep the membrane translationally stationary.

6. The device according to claim 5, wherein the support comprises at least one fixed part and at least one movable part which, when displaced from a first position to a second position, allows a direct contact between the membrane and the deformation parts.

7. The device according to claim 6, wherein the support has a circular shape, the at least one movable part being displaced after an application of a predetermined rotational torque to the at least one movable part.

8. The device according to claim 1, comprising at least one insert connected to the membrane and allowing heat to be transferred to the membrane.

9. The device according to claim 1, wherein the membrane comprises an upper portion arranged to seal the container after applying a predetermined rotational torque to the membrane.

10. The device according to claim 1, wherein the membrane comprises several compartments, wherein each compartment of the several compartments collects at least one ingredient.
